(19) United States
(12) Patent Application Publication
(10) Pub. No.: US 2012/0158186 A1
(43) Pub. Date: Jun. 21, 2012

(54) METHOD AND ARRANGEMENT FOR MONITORING A COMPONENT

(76) Inventors: Roland Busch, Erlangen (DE); Florian Krug, Munchen (DE)

(21) Appl. No.: 13/391,698

(22) PCT Filed: Aug. 11, 2010
(86) PCT No.: PCT/EP2010/061689

§ 371 Date: Feb. 22, 2012

(30) Foreign Application Priority Data
Aug. 26, 2009 (DE) 10 2009 038 883.4

(51) Int. Cl. G05D 23/00

(52) U.S. Cl. 700/275

(57) ABSTRACT

A method and an arrangement for monitoring a component which is a part of a solar power system is provided. The component receives and converts solar energy using a receiver. The temperature of the receiver of the component is determined using a remote monitoring method. The component is then adjusted or corrected in accordance with the temperature.

### CROSS REFERENCE TO RELATED APPLICATIONS

This application is the US National Stage of International Application No. PCT/EP2010/061689, filed Aug. 11, 2010 and claims the benefit thereof. The International Application claims the benefits of German application No. 10 2009 038 883.4 DE filed Aug. 26, 2009. All of the applications are incorporated by reference herein in their entirety.

### FIELD OF INVENTION

The invention relates to a method and an arrangement for monitoring a component which, as part of a solar power plant, receives and converts solar energy with the aid of a receiver.

### BACKGROUND OF INVENTION

“Solar power plant” is a collective term covering a variety of systems of different design. Included therein, for example, are so-called “concentrated solar power” (CSP) plants, solar tower plants and “parabolic trough” or “concentrated solar power parabolic trough” plants. The term also refers to “concentrated photovoltaic” (CPV) plants.

In principle, in the plants mentioned, incident sunlight, or solar energy, is concentrated with the aid of mirrors and supplied to a receiver. The receiver is arranged at a focal point on a mirror. It absorbs the solar energy supplied to it and converts it.

In a parabolic trough plant, for example, the receiver contains a molten salt and thermal oil as medium. The concentrated solar energy heats the oil or medium, which is supplied to a heat exchanger. Water vapor, for example, is formed in a second circuit by way of the heat exchanger and supplied to a steam turbine for the purpose of generating electrical energy.

In principle it is also possible here to vaporize the medium of the receiver in order that it can be supplied to the heat exchanger in the form of steam.

A concentrated photovoltaic (CPV) plant has a number of modules that are embodied substantially as planar. Each module contains a number of mirrors. Each of the mirrors focuses incident sunlight or solar energy onto an associated receiver that converts the solar energy directly into electrical energy.

In the plants mentioned, the mirrors used are aligned according to the previously determined position of the sun with the aid of an automated tracking controller.

Inaccuracies in control due to the system technology mean that over the course of time the mirrors used are no longer optimally oriented in relation to the current position of the sun, with the result that the power plant experiences losses in efficiency.

Further losses are caused due to aging of individual plant components. In the case of parabolic trough plants, for example, the surfaces of the mirrors and the receivers are exposed to environmental influences that contribute to their wear and tear and so reduce their efficiency. The same applies in the case of concentrated photovoltaic plants, the components of which are likewise disadvantageously exposed to environmental influences.

It is standard practice in the prior art to check components at regular time intervals so that defective components can be replaced as necessary.

This type of maintenance is carried out by specially trained personnel and consequently is both time-intensive and costly.

The number of faulty components cannot be detected in advance. Also, they cannot be pinpointed within the plant itself.

Only the reduced level of efficiency or increasing losses in efficiency can indicate to a limited degree that a certain number of defective components must be present in the plant.

If performance values of the plant decline over the course of time, this could, however, also be due to defective or inaccurate adjustment of the mirrors to track the position of the sun. To detect this it would first be necessary to carry out extensive checks for defective components in order to be able subsequently to reach the conclusion that the solar tracking of the mirrors is incorrect.

### SUMMARY OF INVENTION

The object of the present invention is therefore to disclose an improved method and an arrangement embodied to perform the method by means of which monitoring of a component of a corresponding plant is ensured.

This object is achieved by the features of the claims and by the features of the claims.

Advantageous developments are given in the respective dependent claims.

The method according to the invention is provided for monitoring a component which, as part of a solar power plant, receives and converts solar energy with the aid of a receiver.

The temperature of the receiver of the component is determined with the aid of a wireless remote monitoring method. The component is then adjusted or corrected as a function of the determined temperature.

It is possible to use active or passive remote temperature measuring methods for this.

Active remote temperature measuring methods are preferably based on so-called “Raman spectroscopy”.

This involves irradiating a material that is to be examined with monochromatic light, usually from a laser. Within the spectrum of the light scattered by the sample, further frequencies are observed in addition to the radiated frequency (Rayleigh scattering). The differences in frequency from the radiated light correspond to the energies of the rotational, vibration, phonon or spin-flip processes that are characteristic of the material. In a similar manner to the infrared spectroscopy spectrum, the spectrum obtained allows conclusions to be drawn regarding the substance being examined and thus also its temperature.

Other methods use high-frequency radiation (microwaves) to measure temperature. Such systems preferably make use of so-called “coherent FMCW reflectometry”, where the abbreviation “FMCW” stands for “frequency modulated continuous wave” and describes the measurement signal used.

Passive remote temperature measurement methods analyze the thermal radiation emitted by an object. In the case of the present invention said thermal radiation is directed outward via the mirrors and can therefore be analyzed.

In the method according to the invention the use of infrared remote monitoring is therefore preferred. With the aid thereof an IR beam is directed by the remote monitoring system via the associated mirror onto the receiver in order to determine the external temperature of the receiver by sampling.

In a further preferred embodiment microwaves are used. The microwaves are directed in the form of a beam by a remote monitoring system via the associated mirror onto the receiver in order to determine the external temperature of the receiver by sampling.

The beam is reflected from the surface of the receiver and travels back via the mirror to the remote monitoring system. By comparing the transmitted signal and the received signal it is possible to deduce the measured temperature of the target object—in this case of the reflector.

The temperature at the surface of the receiver is determined by means of the method according to the invention. Deviations of the determined temperature from a reference temperature are thus easily detectable.

In the event of deviations it is possible to conclude that the alignment of the mirror is incorrect or that the mirror has been damaged.

It is thus possible to detect faulty components in advance and identify their location with pinpoint accuracy.

Optimized orientation of the mirrors of the plant through adaptive feedback control is as simple to achieve as locating and replacing defective components.

In the case of a parabolic trough plant, for example, the method according to the invention makes it possible for a plant train of between 10 and 200 m in length to be sampled or monitored using only one remote monitoring device.

The method according to the invention enables the lifetime of a plant to be increased significantly by allowing faulty components to be replaced in good time—at minimum cost in terms of time and labor—before damage is caused to the plant system.

### BRIEF DESCRIPTION OF THE DRAWINGS

The invention is explained in more detail below with reference to a drawing, in which:

FIG. 1 shows a parabolic trough plant in which the method according to the invention is used,

FIG. 2 shows the method according to the invention, illustrated with the aid of a mirror PS with receiver REC of the parabolic trough plant PRA from FIG. 1,

FIG. 3 shows a concentrated photovoltaic plant in which the method according to the invention is used,

FIG. 4 shows possibilities for orienting the modules in the plant shown in FIG. 3.

FIG. 5 shows a detail of the plant shown in FIG. 3 in a magnified view,

FIG. 6 shows the method according to the invention, illustrated with the aid a mirror with receiver of the concentrated photovoltaic plant from FIG. 3.

### DETAILED DESCRIPTION OF INVENTION

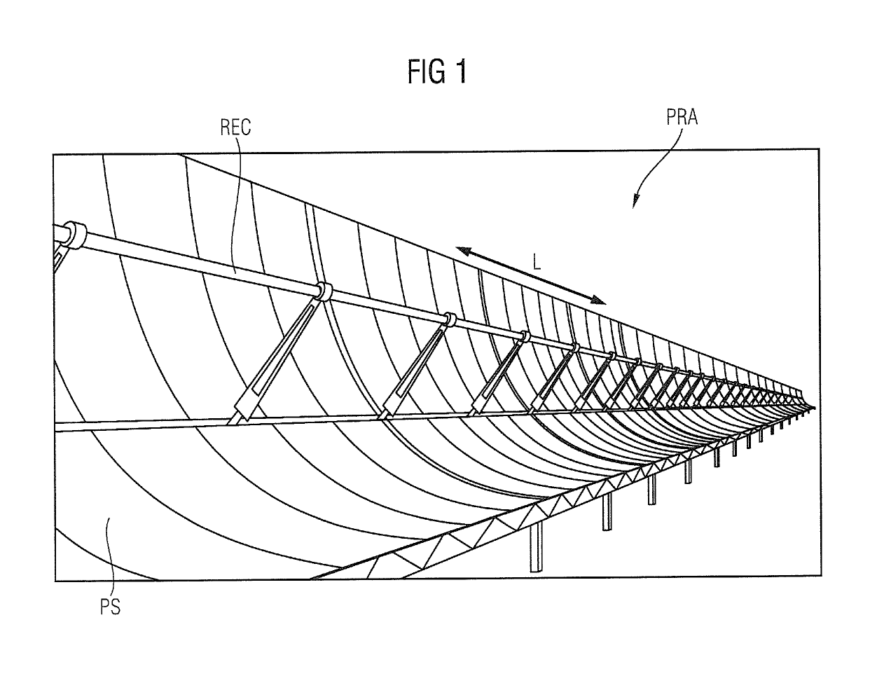

FIG. 1 shows a parabolic trough plant PRA in which the method according to the invention is used.

The parabolic trough plant PRA has a number of parabolic mirrors PS that concentrate incident sunlight onto an associated receiver REC. The receiver REC is thus arranged along a focal line of the associated parabolic mirrors PS.

The parabolic mirrors PS are arranged in a trough shape and are constantly realigned so as to track the course of the sun throughout the day. As a result the incident solar radiation is optimally concentrated onto the associated receiver REC.

The receiver REC consists of a specially coated absorber tube that is embedded in a vacuum-sealed glass tube. The solar radiation acting on the receiver REC heats a medium such as a thermal oil flowing through the absorber tube to 400 degrees Celsius. The thermal oil is then conducted across a heat exchanger (not shown here) in order to produce, with the aid of said heat exchanger, steam in a connected second circuit. The steam is then forwarded to a turbine plant (not shown here) in order to generate power. Typical power plant capacities range between 25 and 200 MW at peak times.

In the case of the parabolic trough plant PRA shown here, individual collector trains or trains of parabolic mirror troughs can, depending on their design, have a length L of between 20 and 150 meters.

For reasons of cost the parabolic mirrors of the parabolic trough plant PRA are in most cases arranged so as only to track the position of the sun along a single axis. In most cases they are arranged in a north-south direction and adjusted to track the sun from east to west over the course of the day.

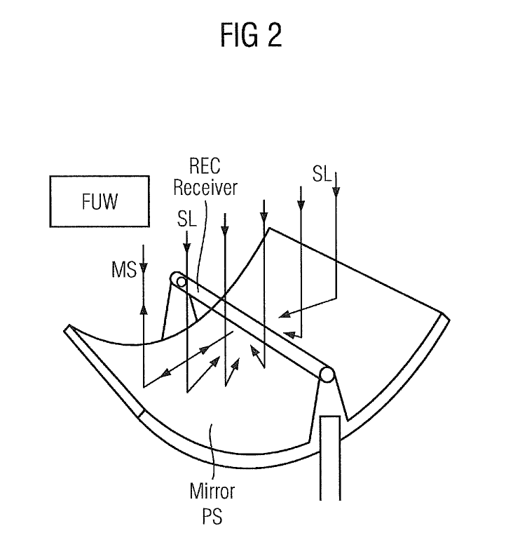

FIG. 2 shows the method according to the invention, illustrated with the aid of a mirror PS with receiver REC of the parabolic trough plant PRA from FIG. 1.

Incident sunlight SL is focused onto the receiver REC with the aid of the mirror PS.

Infrared signals or microwave signals are directed as measurement signals MS by a remote monitoring system FUW (not shown in further detail here) onto the receiver REC via the associated mirror PS.

In this embodiment the measurement signal MS is directed onto the receiver REC at selected points.

The measurement signal MS is reflected from the surface of the receiver REC and travels back to the remote monitoring system FUW via the mirror PS.

By comparing the transmitted measurement signal and the received measurement signal it is possible to deduce the measured temperature of the target object, in this case the temperature of the reflector REC.

An optimized alignment of the mirror PS to the position of the sun at a given time of day can then be carried out by means of feedback-control adjustment on the basis of the determined temperature of the receiver REC in order to increase the capacity of the plant.

It is also possible, on the basis of the determined temperature, to detect:

damage to the mirror PS or
aging of the mirror surface or
damage to the receiver or
aging of the receiver surface.

On the basis of the results of the temperature measurement it is then possible to replace any defective or aged plant components.

The use of active remote temperature monitoring has been described above, though it is of course possible also to use passive remote temperature monitoring in which thermal radiation reflected outward from the receiver is analyzed.

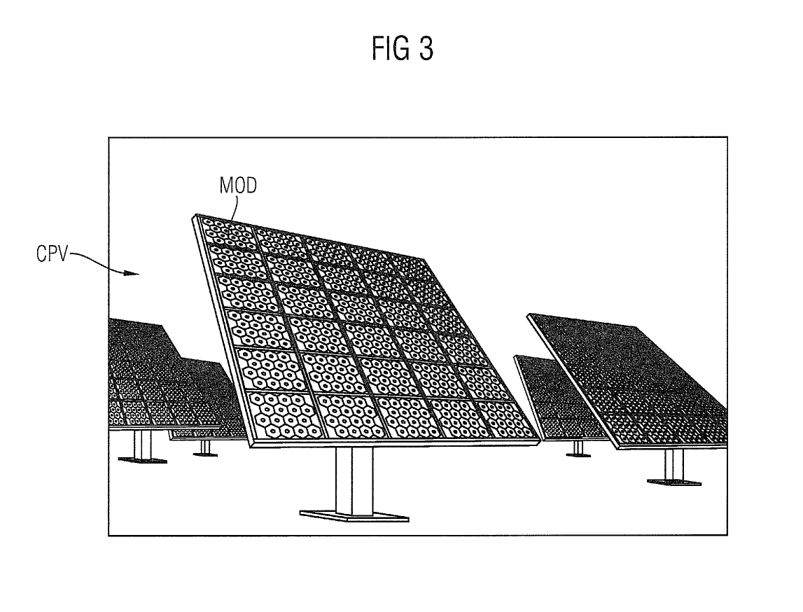

FIG. 3 shows a concentrated photovoltaic plant CPV in which the method according to the invention is used.

The plant CPV shown here has a number (5) of modules MOD in a horizontal arrangement (row) and a number (6) of modules MOD in a vertical arrangement (column).

The modules MOD are embodied as substantially planar. Each module MOD contains a number of mirrors, as will be shown in the ensuing figures.

In the plant CPV shown here the mirrors used are aligned according to the position of the sun with the aid of an automated tracking controller. By means of the controller all 5*6 modules MOD are adjusted simultaneously by way of a module carrier in order to track the sun.

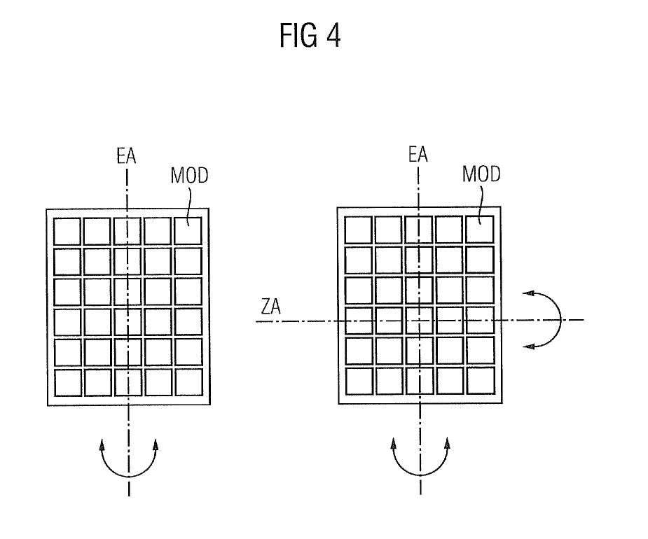

FIG. 4 shows possibilities for orienting the modules MOD in the plant CPV shown in FIG. 3.

The modules MOD are preferably pivoted about a first axis EA by way of the associated module carrier in order to align the mirrors of the associated modules in relation to the position of the sun.

Alternatively or in addition thereto the modules MOD are pivoted about a second axis ZA by way of the associated module carrier in order to align the mirrors of the associated modules in relation to the position of the sun.

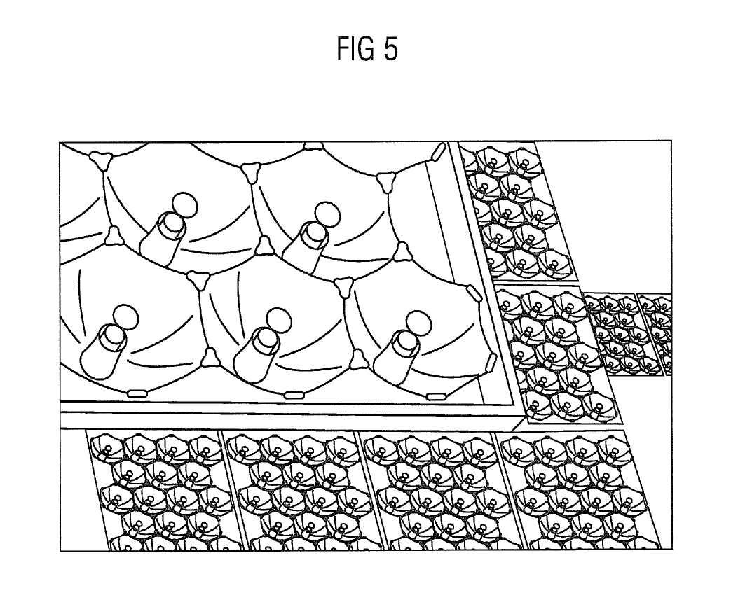

FIG. 5 shows a detail of the plant shown in FIG. 3 in a magnified view.

Individual mirrors of a module can be seen in the top left area of the figure, while other modules with mirrors arranged therein can be seen in the remaining area of the figure.

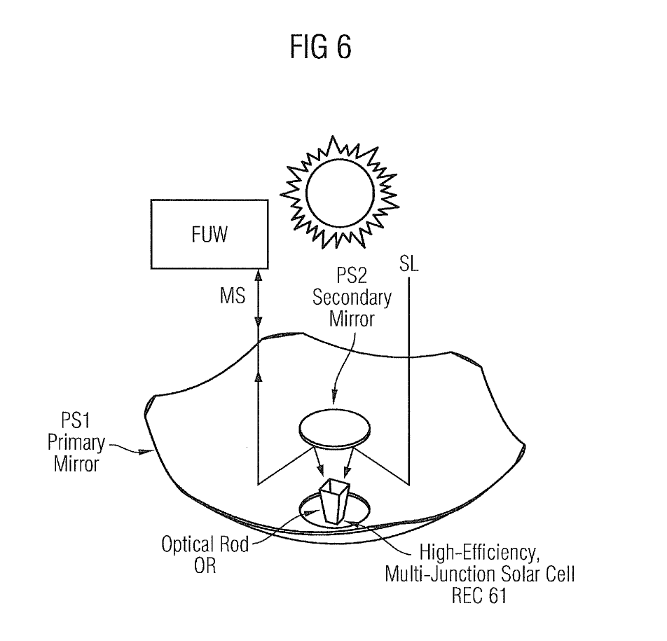

FIG. 6 shows the method according to the invention, illustrated with the aid of mirrors PS1 and PS2 with associated receiver REC 61 of the plant CPV from FIG. 3.

Incident sunlight SL is concentrated onto a receiver REC 61 with the aid of a first (primary) mirror PS1 and with the aid of a second (secondary) mirror PS2.

In a preferred development an optical element, in particular a prism or an optical element known as an “optical rod”, is additionally used to optimize the concentration of energy onto the receiver 61.

The receiver REC 61 is embodied as a semiconductor or as a photovoltaic element and converts the sunlight SL that is focused on it or its solar energy directly into electrical energy.

Infrared signals or microwave signals are directed as measurement signals MS by a remote monitoring system FUW (not shown in further detail here) onto the receiver REC 61 via the associated mirrors PS1, PS2.

The measurement signal MS is reflected by the receiver REC 61 and travels back to the remote monitoring system FUW via the two mirrors PS1 and PS2.

In the case of CPV plants an entire module is preferably sampled over its whole surface with the aid of the measurement signal MS in order to determine a representative temperature for the entire module.

By comparing the transmitted measurement signal and the received measurement signal it is possible to derive the measured temperature of the target object, in this case the representative temperature of the module and thus of the reflectors REC 61 contained in it.

An optimized alignment to the position of the sun at a given time of day can then be carried out by means of feedback-control adjustment on the basis of the determined representative temperature of the module.

It is also possible, on the basis of the determined temperature, to detect:

damage to the mirrors of the module or
aging of the mirror surface or
damage to the receivers of the module or
aging of the receiver surface.

On the basis of the results of the temperature measurement it is then possible to replace defective or aged plant components.

The use of active remote temperature monitoring has been described above, though it is of course possible also to use passive remote temperature monitoring in which thermal radiation reflected outward from the receiver is analyzed.

1-9. (canceled)

10. A method for monitoring a component, comprising:
providing the component, as part of a solar power plant, which receives and converts solar energy with the aid of a receiver;
determining the temperature of the receiver of the component with the aid of a remote monitoring method; and
adjusting or correcting the component as a function of the temperature.

11. The method as claimed in claim 10, wherein the remote monitoring method is a wireless remote monitoring method.

12. The method as claimed in claim 10,
wherein the remote monitoring method sends a wirelessly transmitted measurement signal to the receiver and receives a likewise wirelessly transmitted measurement signal reflected by the receiver, and
wherein the temperature of the receiver is determined by means of a comparison of the two measurement signals.

13. The method as claimed in claim 10, wherein the remote monitoring method uses infrared beams to determine the temperature.

14. The method as claimed in claim 10, wherein the remote monitoring method uses microwaves to determine the temperature.

15. The method as claimed in claim 12,
wherein the measurement signal travels to the receiver from a remote monitoring system via a mirror that is associated with the receiver, and
wherein the measurement signal is reflected by the receiver surface and reflected back via the associated mirror so as to be received by the remote monitoring device.

16. The method as claimed in claim 12, wherein the temperature of the receiver is determined by measuring the temperature at the receiver at selected points.

17. The method as claimed in claim 16, wherein the solar power plant is a parabolic trough plant or a concentrated photovoltaic plant.

18. The method as claimed in claim 17,
wherein in the case of a concentrated photovoltaic plant, the representative temperature for a module is determined,
wherein the module comprises a plurality of minors and receivers, and
wherein the module is sampled over the entire surface by means of the measurement signal in order to determine the temperatures of the receivers that are arranged in the module.

19. The method as claimed in claim 18, wherein the minors are realigned by means of a feedback-control adjustment to track the current position of the sun as a function of the temperature.

20. The method as claimed in claim 12, wherein the location of defective components within the plant is pinpointed with the aid of the temperature measurement in order to allow their repair or replacement.

21. An arrangement for performing the method as claimed in claim 10, comprising:
a component which, as part of a solar power plant, receives and converts solar energy with the aid of a receiver; and
a remote monitoring device which determines the temperature of the receiver of the component with the aid of wirelessly transmitted measurement signals in order to adjust or correct the component as a function of the temperature.

22. The arrangement as claimed in claim 21,
wherein a wirelessly transmitted measurement signal is sent to the receiver and likewise a wirelessly transmitted measurement signal is reflected by the receiver, and
wherein the temperature of the receiver is determined by means of a comparison of the two measurement signals.

23. The arrangement as claimed in claim 21, wherein infrared beams are used to determine the temperature.

24. The arrangement as claimed in claim 21, wherein microwaves are used to determine the temperature.

25. The arrangement as claimed in claim 22,
wherein the measurement signal travels to the receiver from a remote monitoring system via a mirror that is associated with the receiver, and
wherein the measurement signal is reflected by the receiver surface and reflected back via the associated mirror so as to be received by the remote monitoring device.

26. The arrangement as claimed in claim 22, wherein the temperature of the receiver is determined by measuring the temperature at the receiver at selected points.

27. The arrangement as claimed in claim 26, wherein the solar power plant is a parabolic trough plant or a concentrated photovoltaic plant.

28. The arrangement as claimed in claim 27,
wherein in the case of a concentrated photovoltaic plant, the representative temperature for a module is determined,
wherein the module comprises a plurality of mirrors and receivers, and
wherein the module is sampled over the entire surface by means of the measurement signal in order to determine the temperatures of the receivers that are arranged in the module.

29. The arrangement as claimed in claim 28, wherein the mirrors are realigned by means of a feedback-control adjustment to track the current position of the sun as a function of the temperature.
